(19) United States
(12) Patent Application Publication
(10) Pub. No.: US 2005/0237296 A1
(43) Pub. Date: Oct. 27, 2005

(54) Apparatus, system and method for virtual user interface

(75) Inventor: Dong-Seok Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/060,397

(22) Filed: Feb. 18, 2005

(30) Foreign Application Priority Data
Apr. 23, 2004 (KR) 2004-28078

(51) Int. Cl. G09G 5/00

(52) U.S. Cl. 345/156

(57) ABSTRACT

A Virtual user interface apparatus, system, and method are provided, wherein the virtual user interface apparatus comprises a movement detection unit for detecting a movement degree of an actual hand, a bend detection and restriction unit for detecting a bend degree of a finger of the actual hand and restricting the bend of the finger when a control signal is received from a host device, and an external interface unit for transferring the detected movement degree and the bend degree to the host device, and receiving and transferring the control signal, which is generated by the host device by use of the movement degree, the bend degree, and information on a certain 3-dimensional shape, to the bend detection and restriction unit Accordingly, the grip of a product can be virtually examined without having to make a mock-up of the product. Thus, money and time are saved by not making a mock-up of the product

### CROSS-REFERENCE TO RELATED APPLICATIONS

This application claims priority under 35 U.S.C. § 119(a) to an application entitled “APPARATUS, SYSTEM AND METHOD FOR VIRTUAL USER INTERFACE” filed in the Korean Intellectual Property Office on Apr. 23, 2004 and assigned Korean Patent Application No. 2004-28078, the entire contents of which are expressly incorporated herein by reference.

### BACKGROUND OF THE INVENTION

1. Field of the Invention

The present invention generally relates to an apparatus, a system, and a method for a virtual user interface. More specifically, the present invention relates to an apparatus, a system, and a method for a virtual user interface, enabling to virtually feel a grip of a virtual 3-dimensional shape.

2. Description of the Related Art

A mobile product such as a camcorder, a ca0000mera, and a mobile phone, needs to provide a user with soft and comfortable grip when the user utilizes the mobile product while holding the mobile product in his or her hand. Grips that are uncomfortable cause the user to become fatigued and are inconvenient. A mobile product, with such an uncomfortable grip, can become a failure on the market, albeit having high performance.

The grip of the mobile product can be examined to some degree through a 3-dimensional shape. It is, however, difficult to accurately examine the grip of the user with respect to a substantial object To accurately examine the grip, a mock-up is built using a chemical wood at a point in the development phase when appearance of the mobile product is finally designed. The grip of the product is examined in person by holding the mock-up in a hand, and it is checked to determine whether there is any inconvenience in operating the buttons of the product by the user.

It requires a great deal of time and cost, however, to make the mock-up of the mobile product. What is worse, the mobile product that has a complicated shape increases the required time and cost. In addition, it is impossible to modify the shape of the mock-up after the creation. Accordingly, a new mock-up has to be re-created to make up for design defects if it is determined that the created mock-up proves an uncomfortable grip or improper locations of the buttons; this, of course, requires additional time and cost.

Although the appearance of the mobile product and the locations of the buttons may be modified or altered at the development phase, this is not conducive to an efficient and economic design program. In such situations, the re-creation of the mock-up causes enormous cost and time.

### SUMMARY OF THE INVENTION

To address the above drawbacks of the conventional arrangement, as well as others, an aspect of the present invention provides an apparatus, a system, and a method for a virtual user interface, capable of displaying a virtual hand by detecting motion and bending of an actual hand and allowing to virtually feel a grip by restricting the bend of the actual hand if the virtual hand touches a virtual 3-dimensional shape displayed in a virtual space on the screen.

To achieve the above aspect of the present invention, a virtual user interface apparatus according to an embodiment of the present invention comprises a movement detection unit for detecting a movement degree of an actual hand, a bend detection and restriction unit for detecting a bend degree of a finger of the actual hand and restricting the bend of the finger when a control signal is received from a host device, and an external interface unit for transferring the detected movement degree and the bend degree to the host device, and receiving and transferring the control signal, which is generated by the host device by use of the movement degree, the bend degree, and information on a certain 3-dimensional shape, to the bend detection and restriction unit.

The control signal is generated by the host device according to an embodiment of the present invention when it is determined that a virtual hand displayed on a screen of the host device touches the certain 3D shape displayed on the screen of the host device. The bend detection and restriction unit comprises a motor for rotating in relation with the bend of the finger, a rotation angle detector for detecting the bend degree of the finger by detecting a rotation angle of the motor, and a rotation restrictor for restricting the finger from bending by restricting the rotation of the motor when the control signal is received from the host device. The movement detection unit detects the spatial movement degree of the actual hand by use of an angular rate sensor.

Consistent with the above aspect of the present invention, a virtual user interface system according to an embodiment of the present invention comprises a virtual user interface apparatus for detecting a motion degree of an actual hand and restricting the motion of the actual hand according to a control signal input from outside, and a host device for displaying a virtual hand corresponding to the actual hand on a screen based on the motion degree, and transferring the control signal, which is generated based on the motion degree and information on a certain 3-dimensional shape, to the virtual user interface apparatus.

The virtual user interface apparatus according to an embodiment of the present invention comprises a movement detection unit for detecting a movement degree of the actual hand, and a bend detection and restriction unit for detecting a bend degree of a finger of the actual hand and restricting the bend of the finger when the control signal is received from the host device. The bend detection and restriction unit according to an embodiment of the present invention comprises a motor for rotating in relating with the bend of the finger, a rotation angle detector for detecting the bend degree of the finger by detecting a rotation angle of the motor, and a rotation restrictor for restricting the finger from bending by restricting the rotation of the motor when the control signal is received from the host device.

The host device according to an embodiment of the present invention generates the control signal when it is determined that the virtual hand displayed on the screen touches the certain 3D shape. The host device determines that the virtual hand touches the certain 3D shape if coordinates on the viral hand in a virtual space are identical to coordinate of the virtual space of a mesh with respect to the certain 3D shape.

Consistent with another aspect of the present invention, a virtual user interface method comprises displaying a certain 3-dimensional shape on a screen, detecting a motion degree of an actual hand, displaying a virtual hand corresponding to the actual hand on the screen based on the motion degree, and restricting a motion of the actual hand based on the motion degree and information on the certain 3D shape.

The step of detecting a motion degree of an actual hand according to an embodiment of the present invention comprises detecting a movement degree of the actual hand, and detecting a bend degree of a finger of the actual hand. The step of restricting a motion of the actual hand according to an embodiment of the present invention restricts the motion of the actual hand when it is determined that the virtual hand displayed on the screen touches the certain 3D shape displayed on the screen. The step of restricting a motion of the actual hand determines that the virtual hand touches the certain 3D shape if coordinates on the virtual hand in a virtual space are identical to coordinates of the virtual space of a mesh with respect to the certain 3D shape.

### BRIEF DESCRIPTION OF THE DRAWING FIGURES

These and/or other aspects and advantages of the invention will become apparent and more readily appreciated from the following description of exemplary embodiments, taken in conjunction with the accompanying drawing figures of which:

FIG. 1 is a schematic block diagram of a virtual user interface system according to an embodiment of the present invention;

FIG. 2 is a view of a virtual user interface apparatus of FIG. 1;

FIG. 3 is a block diagram of the bend detection and restriction unit of FIG. 2;

FIG. 4 is a flowchart of a virtual user interface method according to an embodiment of the present invention; and

FIGS. 5A through 5D are views illustrating the virtual user interface method of FIG. 4

### DETAILED DESCRIPTION OF THE EXEMPLARY EMBODIMENTS

Several embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein have been omitted for conciseness and clarity.

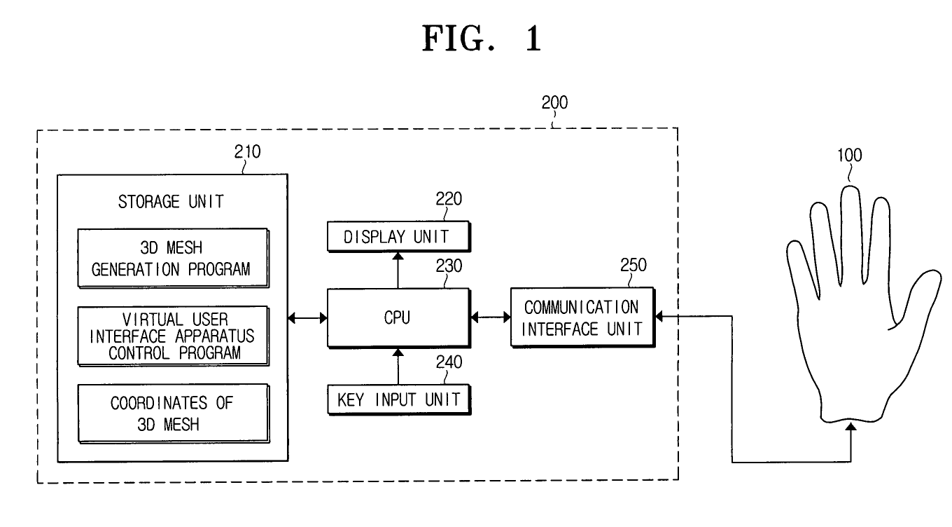

FIG. 1 is a schematic block diagram of a virtual user interface system according to an embodiment of the present invention. Referring to FIG. 1, the virtual user interface system includes a virtual user interface apparatus 100 and a personal computer (PC) 200, which is a host device. The PC 200 displays the motion of an actual hand of a user on a screen as it is, by processing data input from the virtual user interface apparatus 100. The PC 200 transfers a control signal to the virtual user interface apparatus 100 to restrain the motion of the user's actual hand. The PC 200 includes a storage unit 210, a display unit 220, a central processing unit (CPU) 230, a key input unit 240, and a communication interface unit 250.

The storage unit 210 is a recording medium for storing data, operating programs, and application programs used in the PC 200. According to an exemplary embodiment of the present invention, the storage unit 210 is implemented by a hard disk drive. The storage unit 210 stores a 3-dimensional mesh generation program, a virtual user interface apparatus control program, and coordinates of the 3D mesh, which are required to implement the virtual user interface system.

The 3D mesh generation program creates a virtual 3D shape using data input from the user and creates a 3D mesh with respect to the created 3D shape. The virtual user interface apparatus control program displays the motion of the actual hand on the screen as it is by using data input from the virtual user interface apparatus 100. If necessary, the virtual user interface apparatus control program restricts the motion of the actual hand.

The coordinates of the 3D mesh are coordinates with respect to the 3D mesh created by the 3D mesh generation program. The display unit 220 is a display device for displaying the 3D shape and a virtual hand on the screen. According to an exemplary embodiment of the present invention, the display unit 200 is implemented by a monitor. The key input unit 240 is a user interface device that receives and transfers the data regarding the 3D shape from the user to the CPU 230. According to an exemplary embodiment of the present invention, the key input unit 240 is implemented by a keyboard. The communication interface unit 250 communicates data with the virtual user interface apparatus 100 under the control of the CPU 230.

The CPU 230 receives data input from the key input unit 240 and the virtual user interface apparatus 100, and processes the received data by executing the programs stored in the storage unit 210. As a result of the processing of the CPU 230, the 3D shape input by the user and the virtual hand are displayed on the screen of the display unit 220. The CPU 230 transfers the control signal for restricting the motion of the user's actual hand by use of the process result of the CPU 230, to the virtual user interface apparatus 100 through the communication interface unit 250.

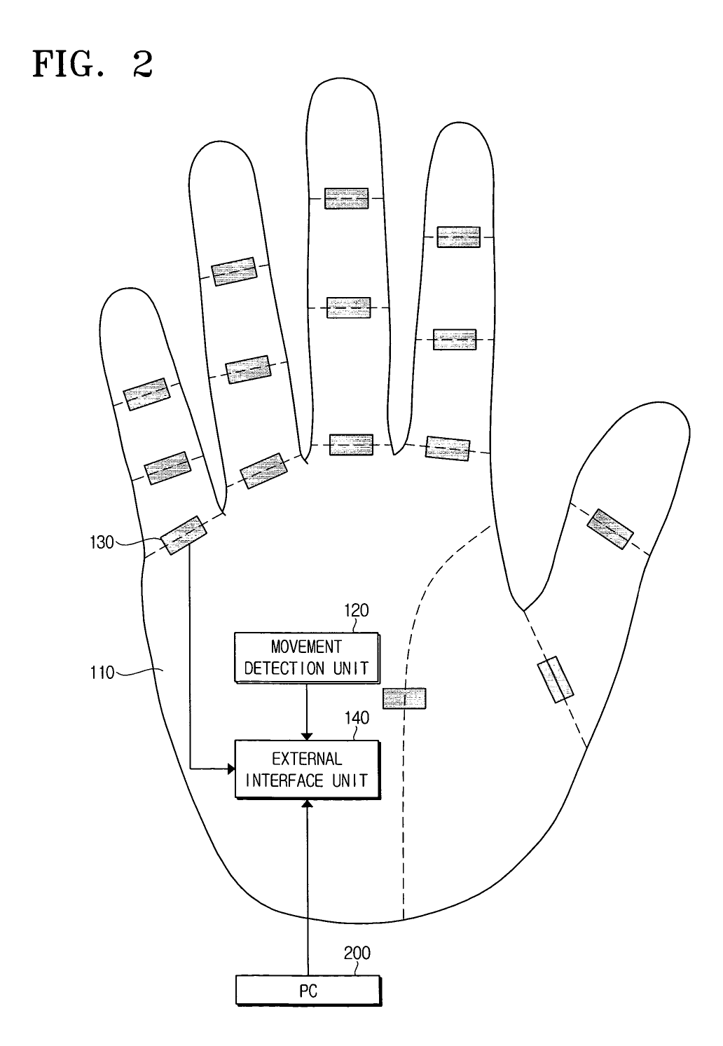

The virtual user interface apparatus 100 of FIG. 1, will now be described in greater detail with reference to FIG. 2. Referring to FIG. 2, the virtual user interface apparatus 100 includes a glove 110, a movement detection unit 120, a plurality of bend detection and restriction units 130, and an external interface unit 140. The user can move his/her hand, and bend fingers while wearing the glove 110. The external interface unit 140 communicates data with the PC 100.

The movement detection unit 120 can be located anywhere on the glove 110. The movement detection unit 120 detects motion of the glove 110, which therefore detects movement of the user's actual hand, and transfers the amount of detected movement degree to the PC 200 through the external interface unit 140. The movement detection unit 120 can be implemented to detect a spatial motion of the user's actual hand by use of three gyro sensors (angular rate sensors) in three axes (X axis, Y axis, and Z axis).

The bend detection and restriction units 130 are located on finger joints of the glove 110. One finger has three joints, and therefore one hand has 15 joints. It is advantageous that there are 15 bend detection and restriction units 130 in accordance with the number of the finger joints (indicated as shaded boxes in FIG. 2). The bend detection and restriction units 130 detect and/or restrict bend of the finger joints of the user's actual hand.

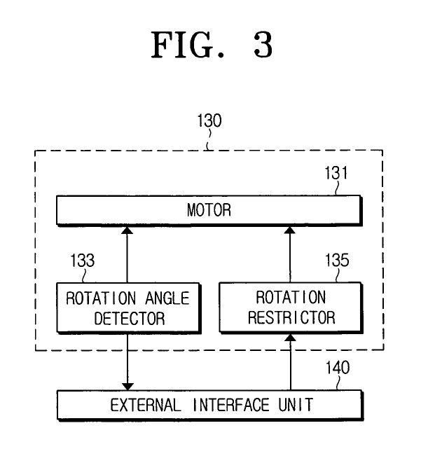

The bend detection and restriction units 130 will now be described in greater detail in reference to FIG. 3. Referring to FIG. 3, the bend detection and restriction units 130 each include a motor 131, a rotation angle detector 133, and a rotation restrictor 135. The motor 131 rotates in relation with the bend of the finger joint of the user's actual hand. The rotation angle detector 133 detects a rotation angle of the motor 131. The rotation angle of the motor 131 is determined by the bend degree of the finger joint of the user's actual hand. Thus, the rotation angle detected by the rotation angel detector 133 corresponds to the degree of bend of the finger joint of the user's actual hand. The detected rotation angle is transferred to the PC 200 through the external interface unit 140.

Upon receiving the control signal to restrict the bend of the joints from the PC 200 through the external interface unit 140, the rotation restrictor 135 restricts the motor 131 from rotating in a specific direction. In result, the user cannot bend the finger joint in the specific direction.

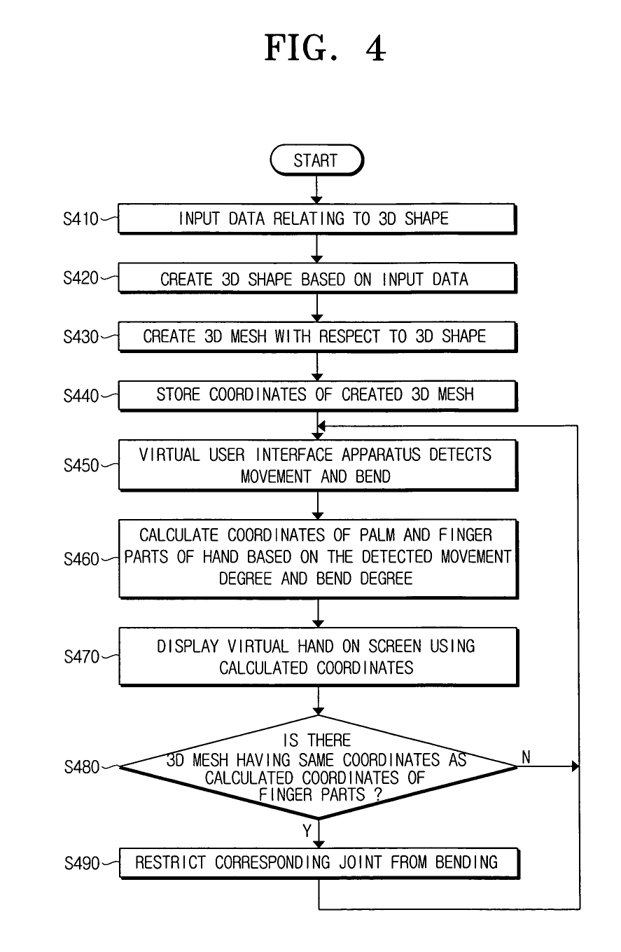

Operation of the virtual user interface system of FIG. 1 will now be described in greater detail in reference to FIG. 4. FIG. 4 is a flowchart of a virtual user interface method according to an embodiment of the present invention. The user determines a 3D shape of a grip to be examined, and inputs data relating to the 3D shape into the PC 200 at step S410. The user inputs the data using the key input unit 240.

The PC 200 creates the 3D shape based on the input data at step S420, and creates the 3D mesh with respect to the created 3D shape at step S430. When the CPU 230 executes the 3D mesh generation program stored in the storage unit 210, the data relating to the 3D shape is processed, and the 3D shape and the 3D mesh are created. The density of the 3D mesh can be set by the user. The higher the density, the greater the performance of the virtual user interface system.

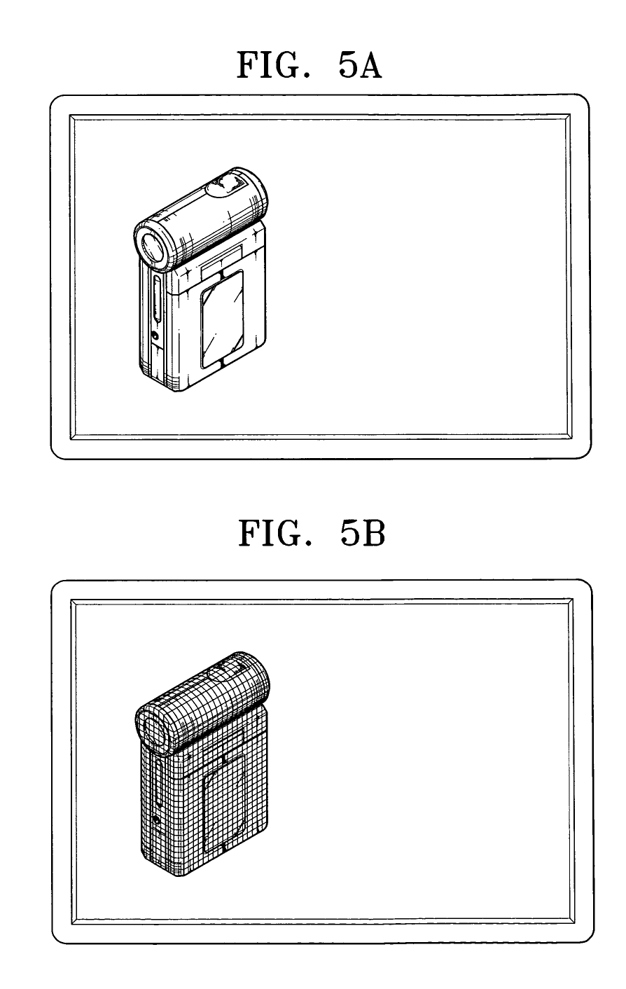

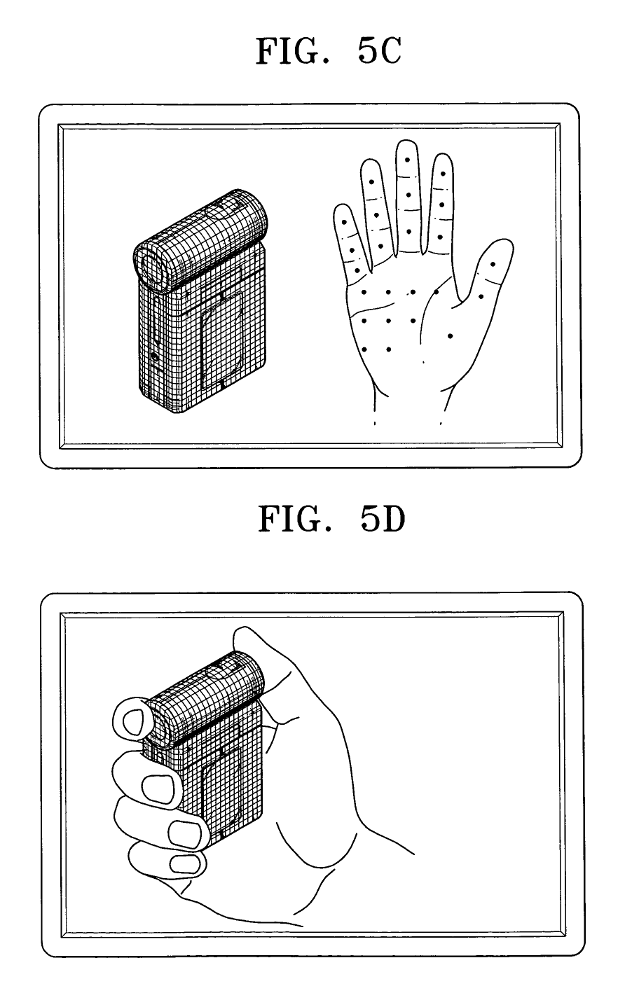

The created 3D shape and 3D mesh are displayed on the display unit 220. For example, FIG. 5A depicts a camcorder, which is an example of a 3D shape. The 3D shape is displayed on the display unit 220. FIG. 5B depicts the 3D mesh created on the 3D shape of the camcorder. Referring to FIG. 5B, the 3D mesh corresponds to cross points of line segments. Hence, the 3D mesh can be represented as coordinates in space. After creating the 3D mesh, the PC 200 stores the coordinates of the created 3D mesh in the storage unit 210 at step S440.

At this point, the PC 200 has completed the process of creating the 3D shape for which a grip is to be examined. Next, the user's virtual hand needs to be displayed in virtual space together along with the 3D shape. In addition to just the user's hand being displayed in virtual space with the 3D shape, the motion of the user's actual hand through the virtual user interface apparatus 100. In addition, the user has to be allowed to virtually feel the grip with respect to the 3D shape.

To this end, the virtual user interface apparatus 100 detects the motion and the bend of the user's actual hand at step S450. To accomplish this, the movement detection unit 120 detects the movement of the user's actual hand, and transfers the detected motion to the PC 200 through the external interface unit 140.

The bend detection and restriction unit 130 detects the bend degree of the joints of the user's actual hand, and transfers the detected bend degree to the PC 200 through the external interface unit 140. The bend degree corresponds to the rotation angle of the motor 131, which is detected by the rotation angle detector 133 of the bend detection and restriction unit 130. As aforementioned, the rotation angle of the motor 131 is determined according to the bend degree of the joint of the user's hand.

Next, the PC 200 calculates the coordinates of the palm and three parts of each finger of the user's actual hand based on the detected motion degree and bend degree at step S460, and displays the virtual hand on the screen of the display unit 220 using the calculated coordinates at step S470. To accomplish this, the CPU 230 performs the calculation and displays the result by use of the virtual user interface apparatus control program stored in the storage unit 210.

The virtual hand displayed on the display unit 220 is illustrated in FIG. 5C. Points on the virtual hand of FIG. 5C are in a virtual space corresponding to the coordinates on the palm and the finger parts calculated at step S460.

In decision step S480, the PC 200 determines whether the 3D mesh has the same coordinates as the calculated coordinates of the finger parts. If the PC 200 determines that the 3D mesh has the same coordinates as the calculated coordinates of the finger parts (“Yes” path from decision step S480), the PC 200 restricts the corresponding joint from bending at step S490. The determination and the restriction are performed with respect to the coordinates of the entire finger parts. The CPU 230 performs the determination and the restriction using the virtual user interface apparatus control program and the coordinates of the 3D mesh stored in the storage unit 210. If the PC 200 determines that the 3D mesh does not have the same coordinates as the calculated coordinates of the finger parts (“No” path from decision step S480), the PC 200 returns to step S450 and continues to detect the movement and bending of the hand, as described above.

The presence of the 3D mesh having the same coordinates as those of the finger parts indicates that the virtual hand touches the virtual 3D shape in the virtual space. Accordingly, the CPU 230 transfers the control signal, which restricts the corresponding joint from bending in a corresponding direction, to the virtual user interface apparatus 100 through the communication interface unit 250.

The control signal is transferred to the bend detection and restriction units 130 located on the corresponding joint through the external interface unit 140. For example, if it is determined that an upper part of the thumb touches the 3D shape, the control signal is transferred to the bend detection and restriction unit 130 located on the first joint of the thumb.

Upon receiving the control signal, the bend detection and restriction unit 130 restricts the joint from bending in the corresponding direction. To accomplish this, the rotation restrictor 135 of the bend detection and restriction 130 restricts the motor 131 from rotating in the corresponding direction. As a result, the user cannot bend the joint in that direction.

The virtual hand can grasp the virtual 3D shape by repeating the steps S450 through S490. FIG. 5D illustrates the screen of the display unit 220 that is displayed as the virtual hand grasps the virtual 3D shape. Referring to FIG. 5D, the bend degree of the virtual hand accords to that of the actual hand. The user can feel the grip virtually.

In an exemplary embodiment of the present invention, the PC 200 is the host device of the virtual user interface apparatus 100. As one of ordinary skill in the art can appreciate, however, such an example is not meant to be limiting. Almost any appropriate apparatus can be the host device, as long as it can interface with the virtual user interface apparatus 100, process the input data, and restrict the motion.

In light of the above described exemplary embodiments of the present invention, the virtual hand is displayed on the screen by detecting the motion of the actual hand. If the virtual hand touches the virtual 3D shape on the screen, the bend of the actual hand is restricted and the user can virtually feel the grip. Accordingly, the grip of a product can be examined without having to make the mock-up of the product. Therefore, both money and time are saved as production of the mock-up of the device is not required. When designing the shape of the product, a developer can easily vary the shape of the product and subsequently the design of the product is facilitated.

While the exemplary embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

1. A virtual user interface apparatus comprising:
a movement detection unit for detecting a movement degree of an actual hand;
a bend detection and restriction unit for detecting a bend degree of a finger of the actual hand and restricting the bend of the finger when a control signal is received from a host device; and
an external interface unit for transferring the detected movement degree and the bend degree to the host device, and receiving and transferring the control signal, which is generated by the host device by use of the movement degree, the bend degree, and information on a certain 3-dimensional (3D) shape, to the bend detection and restriction unit.

2. The virtual user interface apparatus of claim 1, wherein the control signal is generated when it is determined that a virtual hand displayed on a screen of the host device touches the certain 3D shape displayed on the screen of the host device.

3. The virtual user interface apparatus of claim 1, wherein the bend detection and restriction unit comprises:
a motor for rotating in relating with the bend of the finger;
a rotation angle detector for detecting the bend degree of the finger by detecting a rotation angle of the motor; and
a rotation restrictor for restricting the finger from bending by restricting the rotation of the motor when the control signal is received from the host device.

4. The virtual user interface apparatus of claim 1, wherein the movement detection unit detects the spatial movement degree of the actual hand by use of an angular rate sensor.

5. A virtual user interface system comprising:
a virtual user interface apparatus for detecting a motion degree of an actual hand and restricting a motion of the actual hand according to a control signal input from outside; and
a host device for displaying a virtual hand corresponding to the actual hand on a screen based on the motion degree, and transferring the control signal, which is generated based on the motion degree and information on a certain 3-dimensional shape, to the virtual user interface apparatus.

6. The virtual user interface system of claim 5, wherein the virtual user interface apparatus comprises:
a movement detection unit for detecting a movement degree of the actual hand; and
a bend detection and restriction unit for detecting a bend degree of a finger of the actual hand and restricting the bend of the finger when the control signal is received from the host device.

7. The virtual user interface system of claim 6, wherein the bend detection and restriction unit comprises:
a motor for rotating in relating with the bend of the finger,
a rotation angle detector for detecting the bend degree of the finger by detecting a rotation angle of the motor; and
a rotation restrictor for restricting the finger from bending by restricting the rotation of the motor when the control signal is received from the host device.

8. The virtual user interface system of claim 6, wherein the host device generates the control signal when it is determined that the virtual hand displayed on the screen touches the certain 3D shape.

9. The virtual user interface system of claim 8, wherein the host device determines that the virtual hand touches the certain 3D shape if coordinates of the virtual hand in a virtual space are identical to coordinate of the virtual space of a mesh with respect to the certain 3D shape.

10. A virtual user interface method comprising:
a) displaying a certain 3-dimensional (3D) shape on a screen;
b) detecting a motion degree of an actual hand;
c) displaying a virtual hand corresponding to the actual hand on the screen based on the motion degree; and
d) restricting a motion of the actual hand based on the motion degree and information on the certain 3D shape.

11. The virtual user interface method of claim 10, wherein the step of detecting a motion degree of an actual hand comprises:
detecting a movement degree of the actual hand; and
detecting a bend degree of a finger of the actual hand.

12. The virtual user interface method of claim 10, wherein the step of restricting a motion of the actual hand based on the motion degree and information on the certain 3D shape comprises:
restricting the motion of the actual hand when it is determined that the virtual hand displayed on the screen touches the certain 3D shape displayed on the screen.

13. The virtual user interface method of claim 10, wherein the step of restricting a motion of the actual hand based on the motion degree and information on the certain 3D shape comprises:
determining that the virtual hand touches the certain 3D shape if coordinates on the virtual hand in a virtual space are identical to coordinates of the virtual space of a mesh with respect to the certain 3D shape.
